(19) United States
(12) Patent Application Publication
(10) Pub. No.: US 2006/0175849 A1
(43) Pub. Date: Aug. 10, 2006

(54) Animal feces pick-up device

(76) Inventors: Ian H. Warn, Ortonville, MI (US); Philip R. Warn, Ortonville, MI (US)

Correspondence Address: Warn, Hoffmann, Miller & LaLone, P.C., P.O. Box 70098, Rochester Hills, MI, 48307, US

(21) Appl. No.: 11/390,600

(22) Filed: Mar. 28, 2006

Related U.S. Application Data
(63) Continuation of application No. 10/397,395, filed on Mar. 26, 2003.

(51) Int. Cl. A01K 29/00

(52) U.S. Cl. 294/1.4

(57) ABSTRACT

A feces pick-up device combined with a GPS unit. The device includes a handle and jaw configuration which allows the operator to pick up waste ahead and spaced from the operator.

### TECHNICAL FIELD OF THE INVENTION

The present invention relates to an animal feces pick-up device. More particularly, the present invention relates to an improved design which allows for a more comfortable pick-up of animal feces and also tracking of the path of pick-up so that spots are not missed.

### BACKGROUND OF THE INVENTION

There are many types of methods of collecting animal feces such as dog feces, which collect when one owns a pet. These range anywhere from a simple shovel to more sophisticated devices which provide more of a closing jaw type of action for picking up the feces. These devices have drawbacks in one or more areas as follows.

Some devices require two handed operation, which tends to be inconvenient. Many of these devices require being directly over the feces to be picked up. This is sometimes inconvenient. Therefore, it is a goal in the art to provide a method wherein the feces can be picked up without direct vertical engagement, i.e., standing over the feces to be collected.

Additionally, it has been a problem in the art to provide complete collection of the feces over an area. Unless one is very careful when collecting feces, it seems to be a rather formidable task to cover an entire area without missing one or more dog feces. Typically, such mistakes are discovered by other members of the family stepping in the uncollected feces and reporting the breach to other members in the family. Therefore, there remains a need in the art to provide a collection device which allows one to be sure to cover all of a particular area, ensuring complete trackability and collection of the entire area at a particular time.

### SUMMARY OF THE INVENTION

In accordance with the present invention, there is provided a feces collection device which includes a collection member for providing a way to pick up animal feces and, in the broader aspect, a positioning device allowing for tracking of movement of an operator of the device.

The device of the present invention includes a handle member configured for extending in front of the operator of the apparatus and a jaw member which is attached to the handle. The jaw member is used for picking up feces and has a remote apparatus for allowing the operator to close the jaw member for picking up the feces. Preferably, the collection apparatus of the present invention allows one to collect feces spaced from and in front of the operator, and allows a handle member to be positioned from about 5° to about 85° in relationship to the operating position verses the ground.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view showing the overall device of the present invention;

FIG. 2 is a sectional view taken along line 2-2 of FIG. 1;

FIG. 3 is a sectional view of the trigger apparatus taken along line 3-3 of FIG. 1;

FIG. 4 is a detailed view of the collection jaws, taken from the circle of FIG. 1;

FIG. 5 is a detailed front view showing the apparatus of the present invention; and

FIG. 6 is a plan view of a GPS operating in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

In accordance with the present invention, there is shown a feces collection device generally shown at 10. The feces collection device generally comprises a handle portion generally indicated at 12, and a jaws portion generally indicated at 14. A global positioning device generally shown at 14 is attached to the handle. The jaw portion 14 is typically angled with respect to the handle portion and the axis of the jaw A-A such that the place of the jaw edges generally engages the ground, substantially parallel to the ground, shown in the drawing by line G-G. Thus, the angle between the axis of the handle line B-B and the ground is typically from about 5° to about 85°, preferably from about 30° to 75°, and most preferred from 45° to 70°.

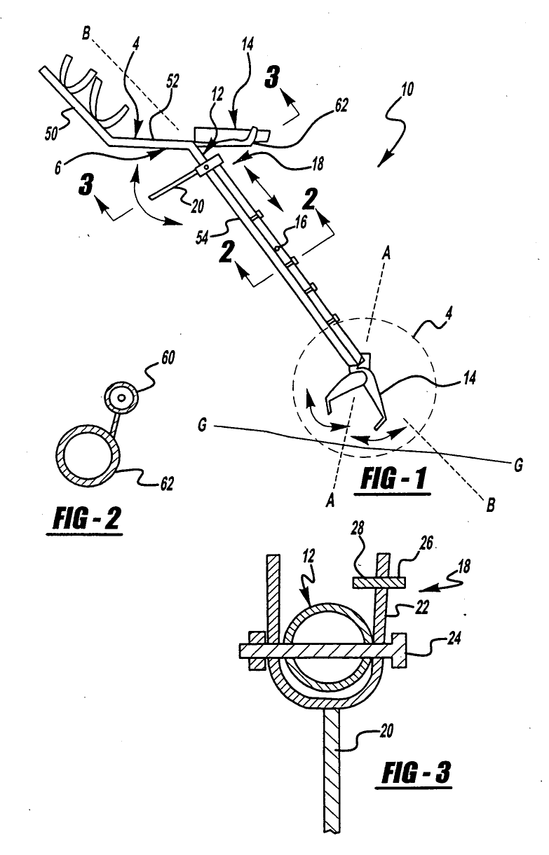

An apparatus generally shown at 16 is provided for closing of the jaws. Apparatus 16 includes a trigger mechanism shown in detail in FIG. 3, indicated by numeral 18. The trigger mechanism includes the trigger 20 attached to a U-shape hinge member 22, which is attached to the handle 12 by way of a bolt or other hinge pin 24. An actuation rod 26 is secured to the U-shaped member 22 through an orifice by way of a bent over portion 28.

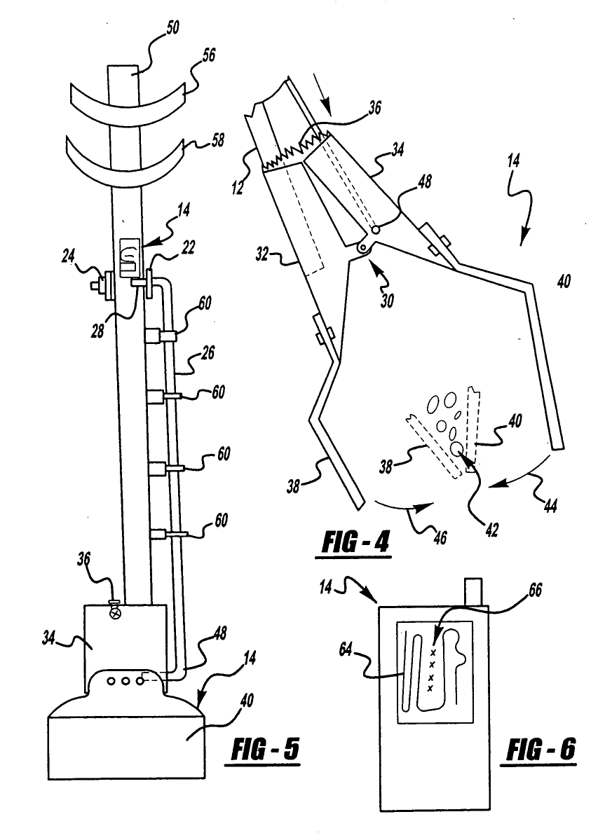

Referring now to FIGS. 4 and 5, there is shown a detailed view of the collection jaws 14. The jaws 14 include a hinge assembly 30 which attaches the jaw one to another. A first jaw member 32 is attached directly to the handle 12, and a second jaw member 34 is hingedly attached at hinge 30 to the first jaw member 32. A spring member 36 draws the rear end of members 32 and 34 together for opening of the jaws. A pair of feces collection attachments 38 and 40 are provided for collecting a feces matter, generally indicated at 42, when the jaws are closed along arrows 44 and 46. This is shown in phantom in FIG. 4. The actuation rod 26 is attached at a second end 48 adjacent the hinge 30, for providing actuation movement of the jaw assembly for closing of the jaws in response to movement of the trigger 20. The actuation rod 26 is guided by a plurality of guide members 60, which are shown in detail in FIG. 2. The guide members provide guidance for the actuation shaft without flexing of the shaft, to provide proper actuation of the jaws 14. It is within the scope of the invention that a push/pull cable or like device could also be used for actuating the jaws.

With respect to the handle portion, the handle portion includes a first arm engaging portion 50, a second handle portion 52 and a third extension portion 54. Arm supporting members 56 and 58 are semi-circular in nature and allow support of the arm while gripping the handle 52. The angle between first portion 50 and second portion 52 is generally from about 90° to about 170°, and preferably 100° to 130°. The angle between handle portion 50 and 52 is dependant on the parameters for the final angle of the handle as set forth above.

Thus in operation, an operator grips the handle 52 and the device rests against arm engagement members 56 and 58 in the operator's hand. The operator may then scan in front of the operator for locating animal feces. Upon seeing a feces, the operator merely grips the trigger mechanism 20 to close the jaws and grip the feces, as shown in phantom in FIG. 4. Upon releasing of the trigger, the feces may be dumped in a suitable container, since the jaws automatically open up due to spring 36.

A Global Positioning System (GPS) mounting plate 62 provides a place for the mounting of a GPS 14. The GPS may be a hand held unit attached with straps or hooks and loop fasteners or the like or integrated with the device. Using the GPS mechanism, the actual movements of the operator can be tracked and measured, such that complete coverage of an area is ensured. Of course, other positioning mechanisms such as loran or the like might be utilized without departing from the scope of the present invention. As shown in FIG. 6, a continuous track 64 can be provided such that missed spots 66 and coverage can be noticed.

Thus, the present invention allows for a one arm pick-up of feces in front of the operator, providing improved identification and pick-up of animal feces. Additionally, using the GPS allows the operator to be more thorough in policing the area.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A feces collection device comprising:
a collection member for providing a way to pick up an animal feces; and
a positioning device allowing for tracking of movement of an operator of the device.

2. The feces collection device of claim 1 wherein said positioning device is a Global Positioning System or loran device capable of showing the ground track.

3. The feces collection device of claim 1 wherein said collection member further comprises a handle operably associated with closeable jaws such that feces can be picked up spaced from and in front of the operator.

4. The feces collection device of claim 3 wherein the handle further comprises an arm engaging area, a grip portion and a handle extension wherein the angle between a plane passing through the jaws and the handle is at an angle of from about 50 to about 85°.

5. The feces collection device of claim 3 wherein the angle is from about 30° to 75°.

6. The feces collection device of claim 5 wherein the angle between the arm engagement portion and the handle portion is from about 90° to about 150°.

7. A feces collection apparatus comprising:
a handle member configured for extending in front of an operator of said apparatus;
a jaw member attached to said handle, said jaw member configured for closing of its jaws substantially parallel to the ground wherein the angle between the ground and said handle member is from about 50 to about 85°; and
a remote apparatus for allowing the operator to close the jaw member.

8. The feces collection apparatus of claim 7, further comprising a GPS or loran unit attached to said handle.

9. A feces collection apparatus comprising:
a handle member configured for extending in front of an operator of said apparatus;
a jaw member attached to said handle member;
an apparatus for allowing remote closing of said jaw member by said operator;
said handle and said jaw member being operably associated such that the jaws can be closed for picking up feces spaced in front of the operator.

10. The feces collection apparatus of claim 9 further comprising a GPS or loran attached to said apparatus.
